(19) United States
(12) Patent Application Publication
(10) Pub. No.: US 2026/0093854 A1
(43) Pub. Date: Apr. 2, 2026

(54) LOW-POWER GLITCH DETECTION CIRCUIT FOR EXPOSED POWER SUPPLIES IN SYSTEM-ON-CHIPS

(71) Applicant: Qorvo US, Inc., Greensboro, NC (US)

(72) Inventors: Toby Balsom, Utrecht (NL); Theo Band, Oostzaan (NL)

(21) Appl. No.: 19/301,091

(22) Filed: Aug. 15, 2025

Related U.S. Application Data
(60) Provisional application No. 63/700,858, filed on Sep. 30, 2024.
(60) Provisional application No. 63/735,368, filed on Dec. 18, 2024.

(51) Int. Cl. G06F 21/81; G01R 19/165; G01R 19/25; G06F 21/55

(52) U.S. Cl. CPC G06F 21/81; G01R 19/16552; G01R 19/2506; G06F 21/556

(57) ABSTRACT

Embodiments of a glitch detector provided in a digital circuit are disclosed. The glitch detector detects glitches in a digital power voltage on a digital power rail. The glitch detector includes glitch detection circuitry and an asymmetric memory element. The glitch detection circuitry is coupled to the digital power rail and is configured to detect a glitch on a digital power voltage on the digital power rail. The asymmetric memory element is operably associated with the glitch detection circuitry so as to generate a glitch detection signal where the glitch detection signal is generated in a detection state in response to the glitch detection circuitry detecting the glitch on the digital power voltage on the digital power rail. The asymmetric memory element is configured asymmetrically such that leaking charge from the asymmetric memory element drives the asymmetric memory element to generate the glitch detection signal in the detection state.

### RELATED APPLICATIONS

This application claims the benefit of provisional patent application Ser. No. 63/735,368, filed Dec. 18, 2024, and claims the benefit of provisional patent application Ser. No. 63/700,858, filed Sep. 30, 2024, the disclosures of which are hereby incorporated herein by reference in their entireties.

### FIELD OF THE DISCLOSURE

This disclosure is related generally to systems and methods of detecting glitches on digital power voltages.

### BACKGROUND

Voltage glitches are a common method used in attacks on digital circuits. In these attacks, an attacker intentionally introduces rapid fluctuations in the digital supply voltage (known as voltage glitches) in order to disrupt the normal operation of the digital circuit. By targeting specific moments in the execution of cryptographic algorithms or other sensitive processes, voltage glitches can cause the digital circuit to behave unpredictably, leading to errors or unintended behavior. These faults can then be exploited to extract secret information (such as cryptographic keys) or to bypass security mechanisms. For example, a voltage glitch may cause the digital circuit to skip certain operations or produce incorrect results that can be analyzed to reveal vulnerabilities in the system. Such attacks exploit the physical characteristics of the hardware, making them difficult to defend against using purely software-based countermeasures.

In previously known digital circuits, a bandgap voltage reference circuit is used to generate a bandgap voltage while a protected regulator creates a supply in which glitches are heavily suppressed. Thus, the power supply of a glitch detector is being protected by a dedicated supply and reference. Although an attacker may try to exploit glitches on the digital supply voltage to disrupt the glitch detection circuit, a bandgap reference and the protected regulator can, in some cases, mitigate such attempts.

However, this approach comes with increased complexity and higher quiescent current consumption. The bandgap reference, the protected regulator, and the glitch detector all draw relatively large amounts of current, which can be problematic for low-power systems on a chip (SoC). In a “sleep mode,” this solution becomes impractical. Moreover, when considering the various paths that a glitch on the digital power voltage could take, it's clear that numerous transfer routes exist through the interface control signals of each block. These control signals are often necessary for functions like tuning and testing. As a result, the complexity of the system can weaken its overall security, requiring more meticulous design and thorough testing to address the potential attack vectors.

### SUMMARY

Embodiment 1. A glitch detector, the glitch detector including: glitch detection circuitry configured to be coupled to a digital power rail, the glitch detection circuitry being configured to detect a glitch on a digital power voltage on the digital power rail; and an asymmetric memory element operably associated with the glitch detection circuitry so as to generate a glitch detection signal that is either in a detection state or a non-detection state, the asymmetric memory element being configured to generate the glitch detection signal in the detection state in response to the glitch detection circuitry detecting the glitch on the digital power voltage on the digital power rail, the asymmetric memory element being configured asymmetrically such that leaking charge from the asymmetric memory element drives the asymmetric memory element to generate the glitch detection signal in the detection state.

Embodiment 2. The glitch detector of embodiment 1, wherein the asymmetric memory element is configured to generate the glitch detection signal in the non-detection state in response to the glitch detection circuitry not detecting the glitch on the digital power voltage on the digital power rail.

Embodiment 3. The glitch detector of embodiment 2, wherein: the asymmetric memory element is configured to receive a reset signal, the reset signal being in either a reset state or a non-reset state, wherein the asymmetric memory element being configured asymmetrically such that, at start up, the asymmetric memory element starts up in the detection state, wherein the asymmetric memory element is configured to be set in the non-detection state in response to the reset signal being in the reset state.

Embodiment 4. The glitch detector of embodiment 3, wherein the glitch detection circuitry includes a down glitch detector configured to detect the glitch as a drop in the digital power voltage on the digital power rail, the asymmetric memory element being responsive to the down glitch detector so as to generate the glitch detection signal in the detection state in response to the down glitch detector detecting the glitch as the drop in the digital power voltage on the digital power rail.

Embodiment 5. The glitch detector of embodiment 4, wherein the glitch detection circuitry further includes: a first filter circuit configured to receive the digital power voltage on the digital power rail and filter noise out of the digital power voltage so as to generate a filtered power voltage; and a second filter circuit configured to receive the filtered power voltage so as to generate a charged filtered power voltage, the second filter circuit being configured to store charge from the filtered power voltage to generate the charged filtered power voltage so that a response to the glitch is slower on the charged filtered power voltage than on the filtered power voltage.

Embodiment 6. The glitch detector of embodiment 5, wherein the down glitch detector is configured to compare the filtered power voltage and the charged filtered power voltage to detect the glitch.

Embodiment 7. The glitch detector of embodiment 3, wherein the glitch detection circuitry includes an up glitch detector configured to detect the glitch as a surge in the digital power voltage on the digital power rail, the asymmetric memory element being responsive to the up glitch detector so as to generate the glitch detection signal in the detection state in response to the up glitch detector detecting the glitch as the surge in the digital power voltage on the digital power rail.

Embodiment 8. The glitch detector of embodiment 7, wherein the glitch detection circuitry further includes: a first filter circuit configured to receive the digital power voltage on the digital power rail and filter noise out of the digital power voltage so as to generate a filtered power voltage; and a second filter circuit configured to receive the filtered power voltage so as to generate a charged filtered power voltage, the second filter circuit being configured to store charge from the filtered power voltage to generate the charged filtered power voltage so that a response to the glitch is slower on the charged filtered power voltage than on the filtered power voltage.

Embodiment 9. The glitch detector of embodiment 8, wherein the up glitch detector is configured to compare the filtered power voltage and the charged filtered power voltage to detect the glitch.

Embodiment 10. The glitch detector of embodiment 1, wherein the asymmetric memory element includes: P-channel field effect transistors (PFETs); and N-channel field effect transistors (NFETs), wherein the asymmetric memory element is asymmetric such that leaking the charge from the asymmetric memory element drives the asymmetric memory element to generate the glitch detection signal in the detection state by having the NFETs larger than the PFETs.

Embodiment 11. The glitch detector of embodiment 10, wherein the asymmetric memory element further includes: second PFETs; and second NFETs, wherein the asymmetric memory element is asymmetric such that leaking the charge from the asymmetric memory element drives the asymmetric memory element to generate the glitch detection signal in the detection state by having the second PFETs larger than the second NFETs, wherein the PFETs are first PFETs and the NFETs are first NFETs.

Embodiment 12. The glitch detector of embodiment 1, wherein the asymmetric memory element includes: PFETs; and NFETs, wherein the asymmetric memory element is asymmetric such that leaking the charge from the asymmetric memory element drives the asymmetric memory element to generate the glitch detection signal in the detection state by having the PFETs larger than the NFETs.

Embodiment 13. The glitch detector of embodiment 1, wherein the asymmetric memory element includes a first logic gate, the first logic gate including: first PFETs; and first NFETs, wherein the asymmetric memory element is asymmetric such that leaking the charge from the asymmetric memory element drives the asymmetric memory element to generate the glitch detection signal in the detection state by having the first NFETs larger than the first PFETs; a second logic gate, the second logic gate including: second PFETs; and second NFETs, wherein the asymmetric memory element is asymmetric such that leaking the charge from the asymmetric memory element drives the asymmetric memory element to generate the glitch detection signal in the detection state by having the second PFETs larger than the second NFETs.

Embodiment 14. The glitch detector of embodiment 13, wherein the asymmetric memory element includes a set-reset (SR) latch and the first logic gate is a first NOR gate and the second logic gate is a second NOR gate.

Embodiment 15. A method of manufacturing a glitch detector, the method including: forming glitch detection circuitry configured to be coupled to a digital power rail, the glitch detection circuitry being configured to detect a glitch on a digital power voltage on the digital power rail; and forming an asymmetric memory element operably associated with the glitch detection circuitry so as to generate a glitch detection signal that is either in a detection state or a non-detection state, the asymmetric memory element being configured to generate the glitch detection signal in the detection state in response to the glitch detection circuitry detecting the glitch on the digital power voltage on the digital power rail, the asymmetric memory element being configured asymmetrically such that leaking charge from the asymmetric memory element drives the asymmetric memory element to generate the glitch detection signal in the detection state.

Embodiment 16. A digital circuit, the digital circuit including: digital logic; a digital power rail coupled to the digital logic, the digital power rail configured to receive a digital power voltage; and a glitch detector, including: glitch detection circuitry configured to be coupled to the digital power rail, the glitch detection circuitry being configured to detect a glitch on the digital power voltage on the digital power rail; and an asymmetric memory element operably associated with the glitch detection circuitry so as to generate a glitch detection signal that is either in a detection state or a non-detection state, the asymmetric memory element being configured to generate the glitch detection signal in the detection state in response to the glitch detection circuitry detecting the glitch on the digital power voltage on the digital power rail, the asymmetric memory element being configured asymmetrically such that leaking charge from the asymmetric memory element drives the asymmetric memory element to generate the glitch detection signal in the detection state.

Embodiment 17. The digital circuit of embodiment 16, wherein the asymmetric memory element is configured to generate the glitch detection signal in the non-detection state in response to the glitch detection circuitry not detecting the glitch on the digital power voltage on the digital power rail.

Embodiment 18. The digital circuit of embodiment 17, wherein: the asymmetric memory element is configured to receive a reset signal, the reset signal being in either a reset state or a non-reset state, wherein the asymmetric memory element being configured asymmetrically such that, at start up, the asymmetric memory element starts up in the detection state, wherein the asymmetric memory element is configured to be set in the non-detection state in response to the reset signal being in the reset state.

Embodiment 19. The digital circuit of embodiment 18, wherein the glitch detection circuitry includes a down glitch detector configured to detect the glitch as a drop in the digital power voltage on the digital power rail, the asymmetric memory element being responsive to the down glitch detector so as to generate the glitch detection signal in the detection state in response to the down glitch detector detecting the glitch as the drop in the digital power voltage on the digital power rail.

Embodiment 20. The digital circuit of embodiment 19, wherein the glitch detection circuitry further includes: a first filter circuit configured to receive the digital power voltage on the digital power rail and filter noise out of the digital power voltage so as to generate a filtered power voltage; and a second filter circuit configured to receive the filtered power voltage so as to generate a charged filtered power voltage, the second filter circuit configured to store charge from the filtered power voltage to generate the charged filtered power voltage so that a response to the glitch is slower on the charged filtered power voltage than on the filtered power voltage.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates an embodiment of a digital circuit, in accordance with some embodiments;

FIG. 2 illustrates a glitch detector, in accordance with some embodiments;

FIG. 3 illustrates an embodiment of an asymmetric memory element, in accordance with some embodiments;

FIG. 4 illustrates signal diagrams for the glitch detector shown in FIG. 2, in accordance with some embodiments;

FIG. 5 is a flow diagram that illustrates a method of manufacturing a glitch detector, in accordance with some embodiments; and

FIG. 6 illustrates an example of a user element, in accordance with some embodiments.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It should be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It should also be understood that when an element is referred to as being “connected” or “coupled” to another element, it can be directly connected or coupled to the other element or intervening elements may be present. In contrast, when an element is referred to as being “directly connected” or “directly coupled”to another element, there are no intervening elements present.

It should be understood that, although the terms “upper,” “lower,” “bottom,” “intermediate,” “middle,” “top,” and the like may be used herein to describe various elements, these elements should not be limited by these terms. These terms are only used to distinguish one element from another. For example, a first element could be termed an “upper” element and, similarly, a second element could be termed an “upper” element depending on the relative orientations of these elements, without departing from the scope of the present disclosure.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having meanings that are consistent with their meanings in the context of this specification and the relevant art and will not be interpreted in an idealized or overly formal sense unless expressly so defined herein.

Embodiments of a glitch detector provided in a digital circuit are disclosed. The glitch detector detects glitches in a digital power voltage on a digital power rail. The glitch detector includes glitch detection circuitry and an asymmetric memory element. The glitch detection circuitry is coupled to the digital power rail and is configured to detect a glitch on the digital power voltage on the digital power rail. The asymmetric memory element is operably associated with the glitch detection circuitry so as to generate a glitch detection signal where the glitch detection signal is generated in a detection state in response to the glitch detection circuitry detecting the glitch on the digital power voltage on the digital power rail. The asymmetric memory element is configured asymmetrically such that leaking charge from the asymmetric memory element drives the asymmetric memory element to generate the glitch detection signal in the detection state. Due to the asymmetry, an attacker is unable to bypass glitch detection by leaking away the charge because, as the charge is leaked from the asymmetric memory element, an attack is identified. Furthermore, the asymmetric memory element may be started up in the detection state, thereby preventing manipulations of a reset signal from being used to attack the asymmetric memory element. Additionally, in some embodiments, current consumption is only the result of capacitive-switching and leakage and is, therefore, small, which is important for a low-power integrated circuit.

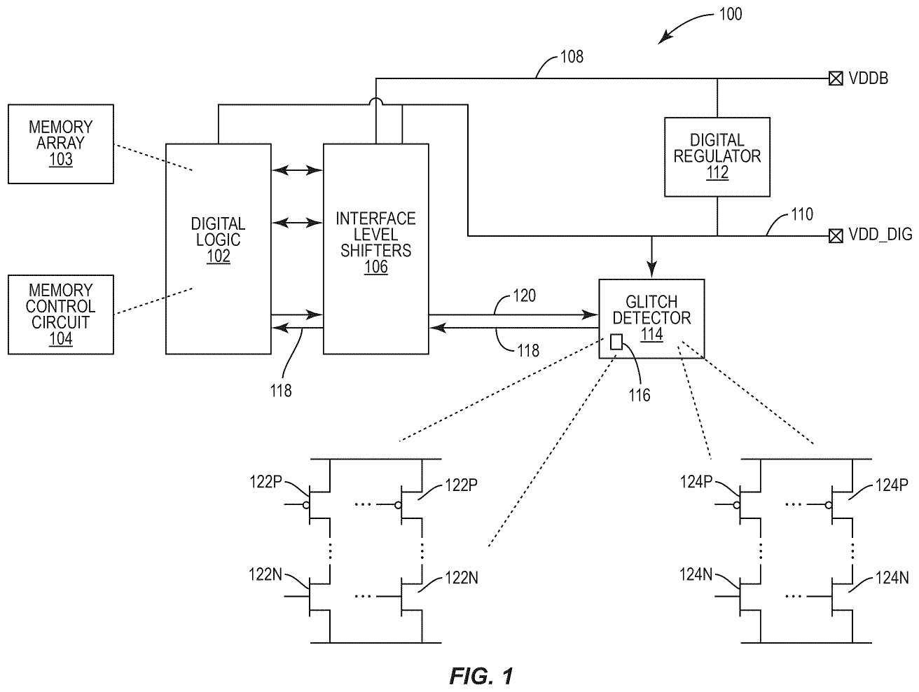

FIG. 1 illustrates an embodiment of a digital circuit 100, in accordance with some embodiments.

The digital circuit 100 includes digital logic 102. Different embodiments of the digital logic 102 may include any type of digital circuitry. For example, the digital logic 102 may include a sequential state pipe line circuit (formed from combinational and sequential logic), a memory array, and/or a digital control circuit. In this embodiment, the digital logic 102 includes a memory array 103 having an array of memory elements and a memory control circuit 104. Interface level shifters 106 is provided in order to supply voltage shifts between different voltage domains in the digital logic 102 and to provide voltage shifts between the digital logic 102 and analog signals provided from analog circuitry that is outside of the digital logic 102.

Two different power rails 108, 110 are provided. The power rail 108 is configured to receive a power voltage VDDB. The power voltage VDDB is configured to be provided at a direct current (DC) power level. Different types of circuitry (such as analog circuitry) are coupled to the power rail 108. The digital power rail 110 is configured to receive a digital power voltage VDD_DIG. The digital power voltage VDD_DIG is configured to be provided at a DC power level that is different than the DC power level of the power voltage VDDB. The digital logic 102 is coupled to the digital power rail 110 such that the digital logic 102 is powered by the digital power voltage VDD_DIG. One of the functions of the interface level shifters 106 is to level shift signals that operate in a domain of the power voltage VDDB into signals that operate in the digital power voltage VDD_DIG, and vice versa.

The digital circuit 100 is protected against power supply glitch attacks. A glitch attack occurs when an exposed port (e.g., a pin that affects the DC voltage level of one of the power voltages VDDB, VDD_DIG) is used to generate a sudden drop or sudden surge in one of the power rails 108, 110. By modifying a printed circuit board (PCB) or by using software, an attacker can automatically generate glitches on one of the power voltages VDDB, VDD_DIG. Then, by programmatically tweaking variables like delay of the glitch at the appropriate timing and relative to a reset event, the attacker can induce an unprotected state in the digital circuit 100. This can lead to private data (e.g., encryption keys stored in secure memory) being accessed by the attacker.

The design challenge of securing the digital circuit 100 is centered on protecting the digital logic 102 from power glitches. For example, a glitch detector 114 protects the memory elements in the memory array 103 from flipping states as a result of the power glitches. Furthermore, the glitch detector 114 is configured to protect the memory control circuit 104 from the power glitches. Furthermore, it should be noted that the glitch detector 114 is configured to protect other components in the digital logic 102 from the power glitches. For example, active digital circuitry such as a serial communication interface (for example, a Universal Serial Bus (USB), a Joint Test Action Group (JTAG), etc.) can be protected by the glitch detector 114. These might include shift-registers, receivers, counters, and other digital components that are passing data to/from/between the memory elements in the memory array 103. If corrupted by the power glitches, these components would have the same impact as if a memory element itself was corrupted. Thus, the glitch detector 112 is configured to protect these components from the power glitches as well, in some embodiments.

The digital circuit 100 includes a digital regulator 112 that is coupled to the power rail 108 and the digital power rail 110. The digital regulator 112 is configured to regulate the power voltage VDDB and the digital power voltage VDD_DIG. The digital regulator 112 is configured to protect the power voltage VDDB from power glitches. However, the digital regulator 112 is incapable of protecting the digital power rail 110 from power glitches due to the digital regulator 112 having insufficient bandwidth. Thus, to protect the digital power voltage VDD_DIG on the digital power rail 110, the digital circuit 100 includes the glitch detector 114.

The glitch detector 114 is coupled to the digital power rail 110 and is configured to detect a glitch on the digital power voltage VDD_DIG. The glitch detector 114 may be configured to detect the glitch as a sudden drop in the digital power voltage VDD_DIG and/or detect the glitch as a sudden surge in the digital power voltage VDD_DIG. The glitch detector 114 includes an asymmetric memory element 116 that is configured to generate a glitch detection signal 118 in either a detection state or a non-detection state. The detection state of the glitch detection signal 118 indicates that a glitch has been detected. The non-detection state of the glitch detection signal 118 indicates that a glitch has not been detected. In some embodiments, the detection state is a high voltage state and the non-detection state is a low voltage state. In other embodiments, the detection state is a low voltage state and the non-detection state is a high voltage state. The asymmetric memory element 116 is configured asymmetrically such that leaking charge from the asymmetric memory element 116 drives the asymmetric memory element 116 to generate the glitch detection signal 118 in the detection state. It should be noted that, in some embodiments, the glitch detector 114 is configured to operate to work with a switch-mode power supply or a DC-to-DC converter. Furthermore, it should be noted that the digital regulator 112 is optional. In some embodiments, the glitch detector 114 is directly connected to the power rail 108 and protects the digital logic 102 from glitches in the power voltage VDDB.

Providing the asymmetric memory element 116 thus ensures that an attacker cannot manipulate the glitch detector 114 at start-up through a reset signal 120 by leaking current from the glitch detector 114. This is because leaking current from the asymmetric memory element 116 automatically generates the glitch detection signal 118 in the detection state when current is leaked out of the glitch detector 114. The detection state is, thus, the default state of the glitch detector 114. Therefore, if the asymmetric memory element 116 is manipulated to store an undefined state, the asymmetric memory element 116 will always result in generating the glitch detection signal 118 in the detection state. In other words, the asymmetry of the asymmetric memory element 116 causes the asymmetric memory element 116 to generate the glitch detection signal 118 in the detection state so that undefined inputs thereby result in the glitch detection signal 118 being generated in the detection state. Asymmetry is also crucial to protect against very long glitch attacks. Very long glitch attacks aim to leak away the charge being stored in memory elements in the memory array 103. However, due to the asymmetry of the asymmetric memory element 116, the asymmetric memory element 116 is the first memory element to leak its charge away to, thus, cause the glitch detection signal 118 to be set in the detection state. This feature identifies glitch attacks before any other one of the memory elements in the memory array 103 are capable of being manipulated.

Through software or hardware designs, the glitch detector 114 is configured to be started up in the detection state. Thus, in order to place the glitch detector 114 in a non-detection state, the glitch detector 114 receives the reset signal 120 from the memory control circuit 104 in a reset state. In response to receiving the reset signal 120 in the reset state, the asymmetric memory element 116 is configured to generate the glitch detection signal 118 to switch from the detection state to the non-detection state, thereby allowing the digital logic 102 to operate. If an attacker tries to manipulate the reset signal 120 in order to make the glitch detector 114 opaque to the reset signal 120, the glitch detector 114 is configured to be started up in the detection state and, thus, the digital logic 102 will not operate and have access to sensitive data in the memory array 103. Any future attack after start-up will be detected regardless of any manipulation of the reset signal 120 since the glitch attack will trigger the asymmetric memory element 116 to generate the glitch detection signal 118 in the detection state, as explained above.

As mentioned above, the asymmetric memory element 116 is configured to leak charge from the asymmetric memory element 116 so as to drive the asymmetric memory element 116 to generate the glitch detection signal 118 in the detection state by having asymmetrically sized field effect transistors (FETs). In some embodiments, the asymmetric memory element 116 includes N-channel FETs (NFETs) 122N and P-channel FETs (PFETs) 122P. The NFETs 122N are larger than the PFETs 122P. For example, the NFETs 122N may have a channel width that is four times larger than a channel width of the PFETs 122P. As such, the NFETs 122N leak current faster than the PFETs 122P. In this case, the asymmetric memory element 116 is driven to a low voltage state since the charge leaks completely out of the NFETs 122N before the charge can completely leak out of the PFETs 122P. In this case, the detection state of the glitch detection signal 118 is the low voltage state and driving the leakage current out of the asymmetric memory element 116 drives the glitch detection signal 118 to the low voltage state.

In some embodiments, the asymmetric memory element 116 includes NFETs 124N and PFETs 124P. The PFETs 124P are larger than the NFETs 124N. For example, the PFETs 124P may have a channel width that is four times larger than a channel width of the NFETs 124N. As such, the PFETs 124P leak current faster than the NFETs 124N. In this case, the asymmetric memory element 116 is driven to a high voltage state since the charge leaks completely out of the PFETs 124P before the charge can completely leak out of the NFETs 124N. In this case, the detection state of the glitch detection signal 118 is the high voltage state and driving the leakage current out of the asymmetric memory element 116 drives the glitch detection signal 118 to the high voltage state.

It should be noted that, in some embodiments, the asymmetric memory element 116 only has the PFETs 122P and the NFETs 122N in order to drive the glitch detection signal 118 to the low voltage state by leaking charge. In other embodiments, the asymmetric memory element 116 only has the PFETs 124P and the NFETs 124N in order to drive the glitch detection signal 118 to the high voltage state by leaking charge. However, in other embodiments, the asymmetric memory element 116 has both the PFETs 122P and the NFETs 122N as well as the PFETs 124P and the NFETs 124N. For example, in some embodiments, the glitch detection signal 118 is a differential signal. Furthermore, in another example, the asymmetric memory element 116 generates both the glitch detection signal 118 and an inverted version of the glitch detection signal 118.

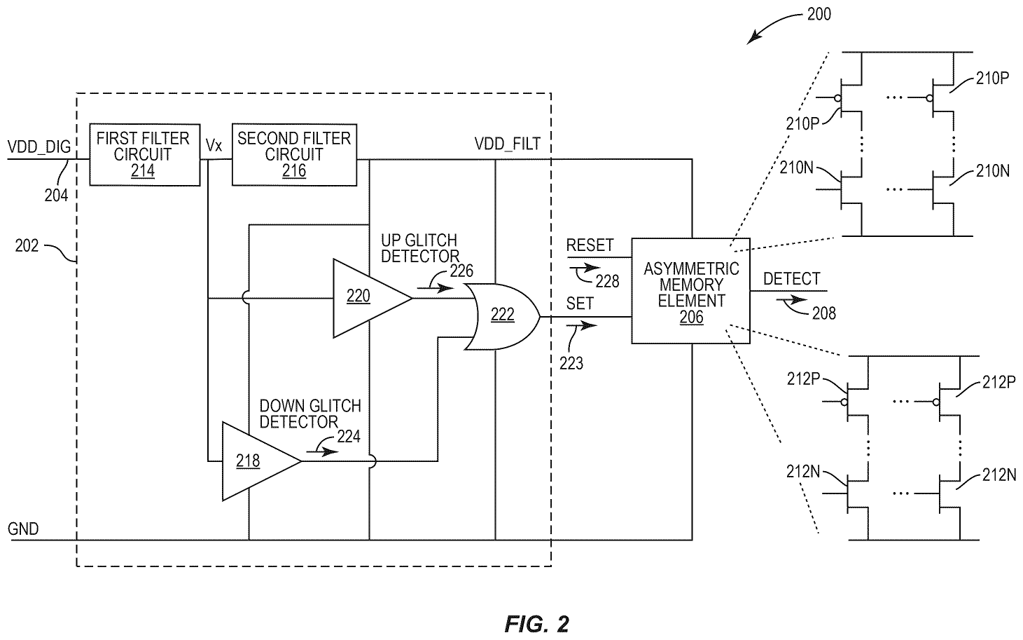

FIG. 2 illustrates a glitch detector 200, in accordance with some embodiments.

The glitch detector 114 shown in FIG. 1 is provided in the same manner as the glitch detector 200, in accordance with some embodiments. The glitch detector 200 includes glitch detection circuitry 202 configured to be coupled to a digital power rail 204. The digital power rail 204 is configured to receive the digital power voltage VDD_DIG. In some embodiments, the digital power rail 204 is the digital power rail 110 shown in FIG. 1. The glitch detection circuitry 202 is configured to detect a glitch on the digital power voltage VDD_DIG on the digital power rail 204.

The glitch detector 200 also includes an asymmetric memory element 206. The asymmetric memory element 206 is operably associated with the glitch detection circuitry 202 so as to generate a glitch detection signal 208 that is either in a detection state or a non-detection state. The asymmetric memory element 206 is configured to generate the glitch detection signal 208 in the detection state in response to the glitch detection circuitry 202 detecting a glitch on the digital power voltage VDD_DIG on the digital power rail 204. The asymmetric memory element 206 is configured to generate the glitch detection signal 208 in the non-detection state in response to the glitch detection circuitry 202 not detecting the glitch on the digital power voltage VDD_DIG on the digital power rail 204. In some embodiments, the asymmetric memory element 116 in FIG. 1 is provided in the same manner as the asymmetric memory element 206 shown in FIG. 2.

The asymmetric memory element 206 is configured asymmetrically such that leaking charge from the asymmetric memory element 206 drives the asymmetric memory element 206 to generate the glitch detection signal 208 in the detection state. In some embodiments, the asymmetric memory element 206 includes NFETs 210N and PFETs 210P. The NFETs 210N are larger than the PFETs 210P. For example, the NFETs 210N may have a channel width that is four times larger than a channel width of the PFETs 210P. As such, the NFETs 210N leak current faster than the PFETs 210P. In this case, the asymmetric memory element 206 is driven to a low voltage state since the charge leaks completely out of the NFETs 210N before the charge can completely leak out of the PFETs 210P. In this case, the detection state of the glitch detection signal 208 is the low voltage state and driving the leakage current out of the asymmetric memory element 206 drives the glitch detection signal 208 to the low voltage state. In some embodiments, the NFETs 210N are the NFETs 122N shown in FIG. 1 and the PFETs 210P are the PFETs 122P shown in FIG. 1.

In some embodiments, the asymmetric memory element 206 includes NFETs 212N and PFETs 212P. The PFETs 212P are larger than the NFETs 212N. For example, the PFETs 212P may have a channel width that is four times larger than a channel width of the NFETs 212N. As such, the PFETs 212P leak current faster than the NFETs 212N. In this case, the asymmetric memory element 206 is driven to a high voltage state since the charge leaks completely out of the PFETs 212P before the charge can completely leak out of the NFETs 212N. In this case, the detection state of the glitch detection signal 208 is the high voltage state and driving the leakage current out of the asymmetric memory element 206 drives the glitch detection signal 208 to the high voltage state. In some embodiments, the NFETs 212N are the NFETs 124N of FIG. 1 and the PFETs 212P are the PFETs 124P of FIG. 1.

In some embodiments, the asymmetric memory element 206 have both the NFETs 210N and the PFETs 210P as well as the NFETs 212N and the PFETs 212P. For example, the glitch detection signal 208 may be generated as a differential signal or the glitch detection signal 208 and an inversion of the glitch detection signal 208 may be generated by the asymmetric memory element 206.

The glitch detection circuitry 202 includes a first filter circuit 214, a second filter circuit 216, a down glitch detector 218, an up glitch detector 220, and an OR gate 222. The first filter circuit 214 is configured to remove high-frequency components above a frequency threshold from the digital power voltage VDD_DIG so as to generate a filtered power voltage Vx. This blocks high-frequency noise from triggering the glitch detector 200. Thus, the frequency value of the frequency threshold depends on a frequency characteristic of the application. In some embodiments, the first filter circuit 214 is a resistor/capacitor (RC) filter. In some embodiments, the second filter circuit 216 is an RC filter circuit.

The second filter circuit 216 is configured to receive the filtered power voltage Vx so as to generate a charged filtered power voltage VDD_FILT. The second filter circuit 216 is configured to store charge from the filtered power voltage Vx to generate the charged filtered power voltage VDD_FILT so that a response to the glitch is slower on the charged filtered power voltage VDD_FILT than on the filtered power voltage Vx. More specifically, the second filter circuit 216 ensures that a discharge rate of the charged filtered power voltage VDD_FILT is much slower than a total propagation delay of a combination of the down glitch detector 218, the up glitch detector 220, the OR gate 222, and the asymmetric memory element 206. In some embodiments, the discharge of the filtered power voltage Vx is 100 times slower than the total propagation delay of the combination of the down glitch detector 218, the up glitch detector 220, the OR gate 222, and the asymmetric memory element 206. This ensures that the glitch detection circuitry 202 is capable of detecting the glitch since the charged filtered power voltage VDD_FILT discharges much slower than a duration of the glitch.

However, the down glitch detector 218 is configured to detect the glitch as a drop in the digital power voltage VDD_DIG on the digital power rail 204. In particular, the down glitch detector 218 compares the charged filtered power voltage VDD_FILT and the filtered power voltage Vx. In response to a difference between the charged filtered power voltage VDD_FILT and the filtered power voltage Vx being greater than a first threshold power voltage, the down glitch detector 218 is configured to generate a first detect signal 224 in a detection state. Otherwise, the down glitch detector 218 generates the first detect signal 224 in a non-detection state. In this case, the detection state is the high voltage state. The first detect signal 224 is received at a first terminal of the OR gate 222. Thus, in response to receiving the first detect signal 224 in the detection state, the OR gate 222 is configured to generate a set signal 223 in a set state (rather than in a non-setting state). In response to receiving the set signal 223 in the set state, the asymmetric memory element 206 is configured to generate the glitch detection signal 208 in the detection state. In this manner, the asymmetric memory element 206 is responsive to the down glitch detector 218 so as to generate the glitch detection signal 208 in the detection state in response to the down glitch detector 218 detecting the glitch as the drop in the digital power voltage VDD_DIG on the digital power rail 204.

Additionally, the up glitch detector 220 is configured to detect the glitch as a surge in the digital power voltage VDD_DIG on the digital power rail 204. In particular, the up glitch detector 220 compares the charged filtered power voltage VDD_FILT and the filtered power voltage Vx. In response to a difference between the charged filtered power voltage VDD_FILT and the filtered power voltage Vx being greater than a second threshold power voltage, the up glitch detector 220 is configured to generate a second detect signal 226 in a detection state. Otherwise, the up glitch detector 220 generates the second detect signal 226 in a non-detection state. In this case, the detection state is the high voltage state. The second detect signal 226 is received at a second terminal of the OR gate 222. Thus, in response to receiving the second detect signal 226 in the detection state, the OR gate 222 is configured to generate the set signal 223 in the set state (rather than the non-setting state). In response to receiving the set signal 223 in the set state, the asymmetric memory element 206 is configured to generate the glitch detection signal 208 in the detection state. In this manner, the asymmetric memory element 206 is responsive to the up glitch detector 220 so as to generate the glitch detection signal 208 in the detection state in response to the up glitch detector 220 detecting the glitch as the surge in the digital power voltage VDD_DIG on the digital power rail 204.

The asymmetric memory element 206 is configured to switch the glitch detection signal 208 from the detection state to the non-detection state in response to receiving a reset signal 228 in the reset state (rather than in a non-reset state). Thus, the asymmetric memory element 206 is configured to be set in the non-detection state in response to the reset signal 228 being in the reset state

In some embodiments, the reset signal 228 is the reset signal 120 shown in FIG. 1. Thus, until the reset signal 228 is received in the reset state, the glitch detection signal 208 remains in the detection state. The asymmetric memory element 206 is configured asymmetrically such that, at start-up, the asymmetric memory element 206 starts up in the detection state. This ensures that an attacker at start-up cannot attack the reset signal 228 since the asymmetric memory element 206 will start up in the detection state and, until the reset signal 228 is received in the reset state, the asymmetric memory element 206 does not switch back to the non-detection state.

The asymmetric memory element 206 is always designed to start in a detection state as the glitch detection signal 208 tends towards the detection state. This protects against potential glitches on the reset signal 228. The reset signal 228 is derived from digital logic (e.g., the digital logic 102 in FIG. 1). Furthermore, with asymmetry, a state change to an “undefined” state will always result in detection since undefined inputs at the input of the asymmetric memory element 206 always tend towards the detection state. Asymmetry is also crucial to protect against very long down glitch attacks. Very long down glitch attacks aim to leak away charge from memory elements in the digital logic (e.g., the memory array 103 in the digital logic 102 in FIG. 1). Due to the asymmetry, the asymmetric memory element 206 leaks away, thus identifying an attack before another memory element in the digital logic flips as a result of the glitch in the digital power voltage VDD_DIG.

The glitch detector 200 meets key security requirements. All the inputs and outputs are either protected or unaffected by varied attack vectors. This means glitch attacks cannot bypass the glitch detector 200. Therefore, the glitch detector 200 provides the same or a better level of protection as compared to traditional glitch detectors. Furthermore, in some embodiments, current consumption is only the result of capacitive-switching and, therefore, leakage is small, which is important for a low-power integrated circuit.

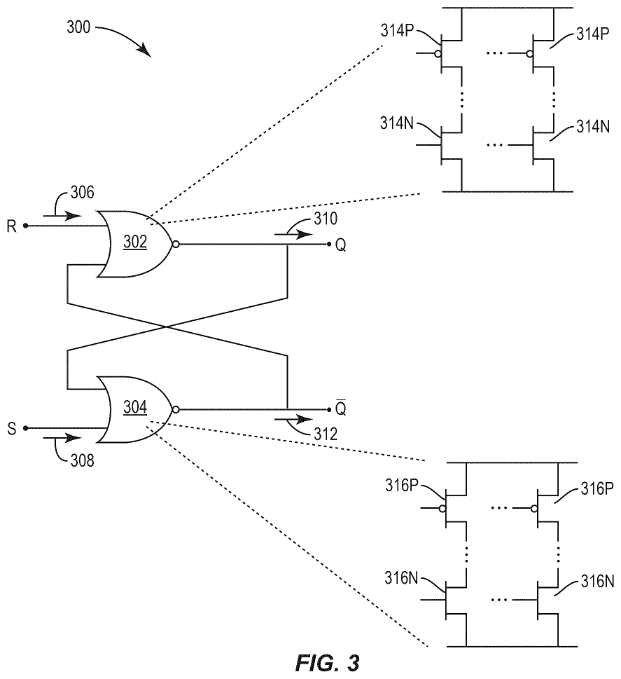

FIG. 3 illustrates an embodiment of an asymmetric memory element 300, in accordance with some embodiments.

In some embodiments, the asymmetric memory element 116 in FIG. 1 and the asymmetric memory element 206 in FIG. 2 are provided in the same way as the asymmetric memory element 300 in FIG. 3. The asymmetric memory element 300 is an asymmetric NOR set-reset (SR) latch. The asymmetric memory element 300 includes a logic gate 302 that is a NOR gate and a logic gate 304 that is a NOR gate. One input of the logic gate 302 is connected to an output of the logic gate 304 and one input of the logic gate 304 is connected to an output of the logic gate 302. Another input of the logic gate 302 is configured to receive a reset signal 306. In some embodiments, the reset signal 306 is the same as the reset signal 228 in FIG. 2. Another input of the logic gate 304 is configured to receive a set signal 308. In some embodiments, the set signal 308 is the same as the set signal 223 in FIG. 2.

The operation of the asymmetric memory element 300 is based on the feedback loop created by connecting the outputs of each of the logic gates 302, 304 to one of the inputs of the other logic gates 304, 302. When both the set signal 308 and the reset signal 306 are in a low voltage state (low voltage state is equivalent to logic 0), a glitch detection signal 310 is generated as an output of the logic gate 302 and an inverted detection signal 312 is generated as an output of the logic gate 304. The glitch detection signal 310 and the inverted detection signal 312 are maintained in the previous state. In some embodiments, the glitch detection signal 310 is an embodiment of the glitch detection signal 208 in FIG. 2 while the inverted detection signal 312 is an inversion of the glitch detection signal 208 in FIG. 2. In response to the set signal 308 being provided in a high voltage state (equivalent to logic 1) and the reset signal 306 being provided in a low voltage state, the logic gate 302 generates the glitch detection signal 310 in the high voltage state (i.e., the detection state, in this case) and the logic gate 304 is generated in a low voltage state. Conversely, in response to the reset signal 306 being provided in the high voltage state and the set signal 308 being provided in the low voltage state, the logic gate 302 generates the glitch detection signal 310 in the low voltage state (the non-detection state, in this case) and the inverted detection signal 312 is generated in the high voltage state.

However, according to the logic of an SR latch, the reset signal 306 being provided in the high voltage state and the set signal 308 being provided in the high voltage state results in undefined logical outputs. However, the asymmetry of the asymmetric memory element 300 is configured to cause the logic gate 302 to generate the glitch detection signal 310 in the high voltage state and the logic gate 304 is configured to generate the inverted detection signal 312 in the low voltage state. Thus, the asymmetry of the logic gate 302 and the logic gate 304 ensures that the logic gate 302 generates the glitch detection signal 310 in the high voltage state and the logic gate 304 generates the inverted detection signal 312 in the low voltage state. This prevents an attacker from attacking the glitch detector 200 in FIG. 2 by using undefined inputs at the asymmetric memory element 206 in FIG. 2 and/or glitches in the digital power voltage VDD_DIG.

More specifically, the logic gate 302 includes PFETs 314P and NFETs 314N. In this embodiment, the PFETs 314P have gate widths that are N times larger than gate widths of the NFETs 314N. In some embodiments, N is equal to 4. This ensures that the logic gate 302 generates the glitch detection signal 310 in the high voltage state as charge leaks out of the logic gate 302. In some embodiments, the PFETs 314P are the PFETs 210P in FIG. 2 and the NFETs 314N are the NFETs 210N in FIG. 2.

Furthermore, the logic gate 304 includes PFETs 316P and NFETs 316N. In this embodiment, the NFETs 316N have gate widths that are N times larger than gate widths of the PFETs 316P. In some embodiments, N is equal to 4. This ensures that the logic gate 304 generates the inverted detection signal 312 in the low voltage state as charge leaks out of the logic gate 304. In some embodiments, the PFETs 316P are the PFETs 212P in FIG. 2 and the NFETs 316N are the NFETs 212N in FIG. 2.

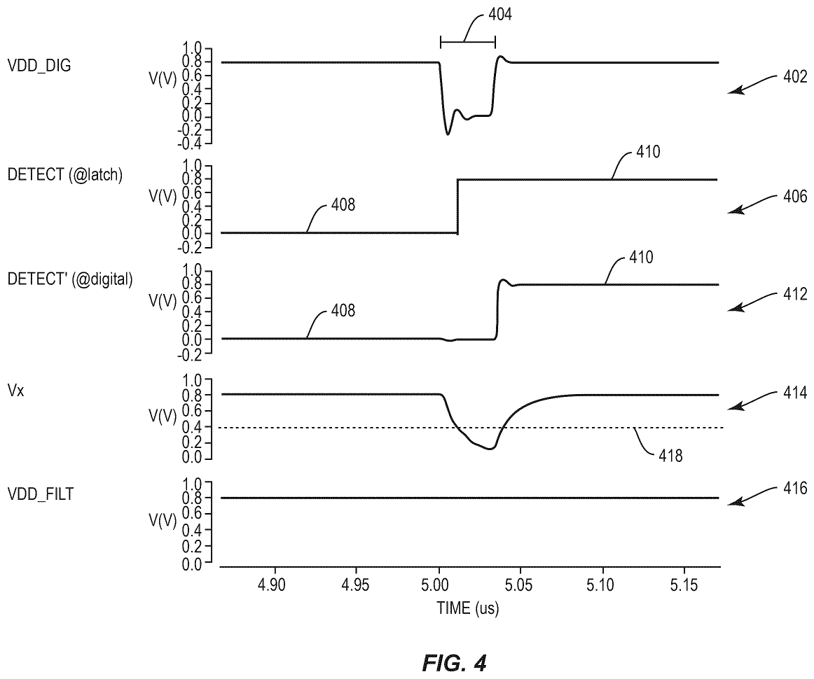

FIG. 4 illustrates signal diagrams for the glitch detector 200 shown in FIG. 2, in accordance with some embodiments.

A top diagram 402 illustrates the digital power voltage VDD_DIG as a function of time. The digital power voltage VDD_DIG shows a glitch 404 as a drop in the digital power voltage VDD_DIG.

A second diagram 406 illustrates a detection signal DETECT, where the detection signal DETECT is configured to switch from a non-detection state 408 to a detection state 410 in response to the glitch 404. As shown in FIG. 4, the identification “(@latch)” means that this is how the detection signal DETECT is shown at an asymmetric memory element, such as the asymmetric memory element 206 shown in FIG. 2.

A third diagram 412 illustrates a detection signal DETECT′, which is a delayed version of the detection signal DETECT. The detection signal DETECT′ illustrates how the detection signal DETECT is received by a control circuit (e.g., the memory control circuit 104 in FIG. 1) in digital logic (e.g., the digital logic 102 in FIG. 1). As shown in FIG. 4, the identification “(@digital)” means that the detection signal DETECT′ is at the control circuit. The detection signal DETECT shows that, despite the glitch 404 temporarily corrupting the digital power voltage VDD_DIG, the detection signal DETECT is transported back to the digital logic and is immune to the attack.

A fourth diagram 414 illustrates the filtered power voltage Vx while a last diagram 416 illustrates the charged filtered power volage VDD_FILT. As shown, the detection signal DETECT is configured to switch from the non-detection state 408 to the detection state 410 in response to the difference between the charged filtered power voltage VDD_FILT and the filtered power voltage Vx exceeding a threshold. This occurs once the filtered power voltage Vx drops below a threshold voltage level 418.

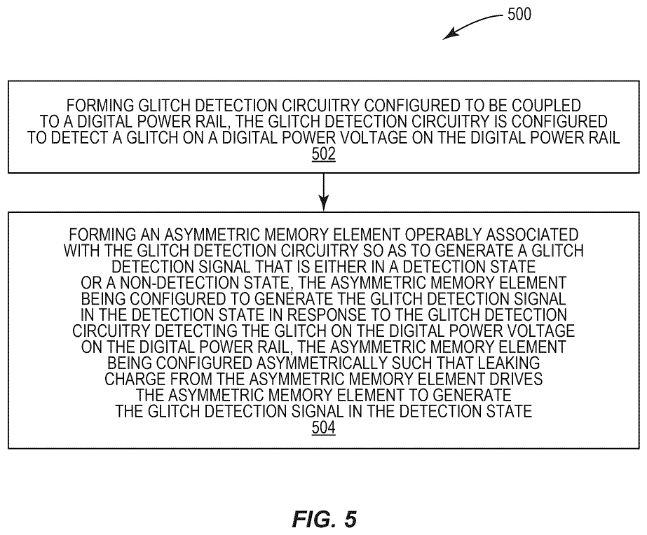

FIG. 5 is a flow diagram 500 that illustrates a method of manufacturing a glitch detector, in accordance with some embodiments.

Examples of the glitch detector that may be manufactured in accordance with the method disclosed in FIG. 5 is the glitch detector 114 shown in FIG. 1 and the glitch detector 200 shown in FIG. 2. The flow diagram 500 includes blocks 502, 504. Flow begins at block 502.

At block 502, glitch detection circuitry configured to be coupled to a digital power rail is formed. The glitch detection circuitry is configured to detect a glitch on a digital power voltage on the digital power rail. An example of the glitch detection circuitry is the glitch detection circuitry 202 in FIG. 2. An example of the glitch is the glitch 404 in FIG. 4. An example of the digital power voltage is the digital power voltage VDD_DIG in FIG. 1, FIG. 2, and FIG. 4. An example of the digital power rail is the digital power rail 110 in FIG. 1 and the digital power rail 204 in FIG. 2. Flow then proceeds to block 504.

At block 504, an asymmetric memory element operably associated with the glitch detection circuitry is formed so as to generate a glitch detection signal that is either in a detection state or a non-detection state. The asymmetric memory element is configured to generate the glitch detection signal in the detection state in response to the glitch detection circuitry detecting the glitch on the digital power voltage on the digital power rail. The asymmetric memory element is configured asymmetrically such that leaking charge from the asymmetric memory element drives the asymmetric memory element to generate the glitch detection signal in the detection state. Examples of the glitch detection signal are the glitch detection signal 118 in FIG. 1, the glitch detection signal 208 in FIG. 2, the glitch detection signal 310 in FIG. 3, and the detection signal DETECT in FIG. 4. Examples of the asymmetric memory element are the asymmetric memory element 116 in FIG. 1, the asymmetric memory element 206 in FIG. 2, and the asymmetric memory element 300 in FIG. 3.

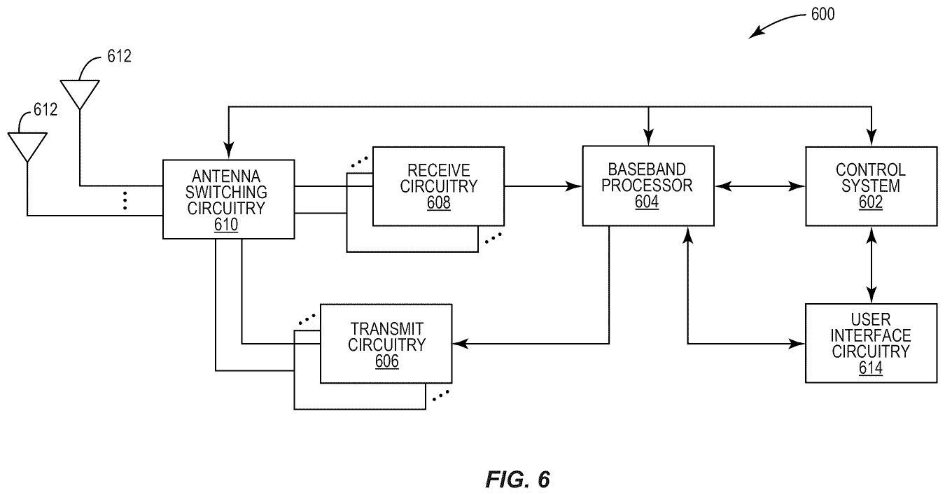

FIG. 6 illustrates an example of a user element 600, in accordance with some embodiments.

With reference to FIG. 6, the concepts described above may be implemented in various types of user elements 600, such as mobile terminals, smart watches, tablets, computers, navigation devices, access points, and like wireless communication devices that support wireless communications, such as cellular, wireless local area network (WLAN), Bluetooth, and near field communications. The user element 600 will generally include a control system 602, a baseband processor 604, transmit circuitry 606, receive circuitry 608, antenna switching circuitry 610, multiple antennas 612, and user interface circuitry 614. In a non-limiting example, the control system 602 may be a field-programmable gate array (FPGA) or an application-specific integrated circuit (ASIC). In this regard, the control system 602 may include at least a microprocessor(s), an embedded memory circuit(s), and a communication bus interface(s). The receive circuitry 608 receives radio frequency signals via the antennas 612 and through the antenna switching circuitry 610 from one or more base stations. A low noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using analog-to-digital converter(s) (ADC).

The baseband processor 604 processes the digitized received signal to extract the information or data bits conveyed in the received signal. This processing typically comprises demodulation, decoding, and error correction operations, as will be discussed in greater detail below. The baseband processor 604 is generally implemented in one or more digital signal processors (DSPs) and application specific integrated circuits (ASICs).

For transmission, the baseband processor 604 receives digitized data, which may represent voice, data, or control information, from the control system 602, which it encodes for transmission. The encoded data is output to the transmit circuitry 606, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission and deliver the modulated carrier signal to the antennas 612 through the antenna switching circuitry 610. The multiple antennas 612 and the replicated transmit and receive circuitries 606, 608 may provide spatial diversity. Modulation and processing details will be understood by those skilled in the art.

Those skilled in the art will recognize improvements and modifications to the preferred embodiments of the present disclosure. All such improvements and modifications are considered within the scope of the concepts disclosed herein and the claims that follow.

What is claimed is:

1. A glitch detector, the glitch detector comprising:
glitch detection circuitry configured to be coupled to a digital power rail, the glitch detection circuitry being configured to detect a glitch on a digital power voltage on the digital power rail; and
an asymmetric memory element operably associated with the glitch detection circuitry so as to generate a glitch detection signal that is either in a detection state or a non-detection state, the asymmetric memory element being configured to generate the glitch detection signal in the detection state in response to the glitch detection circuitry detecting the glitch on the digital power voltage on the digital power rail, the asymmetric memory element being configured asymmetrically such that leaking charge from the asymmetric memory element drives the asymmetric memory element to generate the glitch detection signal in the detection state.

2. The glitch detector of claim 1, wherein the asymmetric memory element is configured to generate the glitch detection signal in the non-detection state in response to the glitch detection circuitry not detecting the glitch on the digital power voltage on the digital power rail.

3. The glitch detector of claim 2, wherein:
the asymmetric memory element is configured to receive a reset signal, the reset signal being in either a reset state or a non-reset state, wherein the asymmetric memory element being configured asymmetrically such that, at start up, the asymmetric memory element starts up in the detection state, wherein the asymmetric memory element is configured to be set in the non-detection state in response to the reset signal being in the reset state.

4. The glitch detector of claim 3, wherein the glitch detection circuitry comprises a down glitch detector configured to detect the glitch as a drop in the digital power voltage on the digital power rail, the asymmetric memory element being responsive to the down glitch detector so as to generate the glitch detection signal in the detection state in response to the down glitch detector detecting the glitch as the drop in the digital power voltage on the digital power rail.

5. The glitch detector of claim 4, wherein the glitch detection circuitry further comprises:
a first filter circuit configured to receive the digital power voltage on the digital power rail and filter noise out of the digital power voltage so as to generate a filtered power voltage; and
a second filter circuit configured to receive the filtered power voltage so as to generate a charged filtered power voltage, the second filter circuit being configured to store charge from the filtered power voltage to generate the charged filtered power voltage so that a response to the glitch is slower on the charged filtered power voltage than on the filtered power voltage.

6. The glitch detector of claim 5, wherein the down glitch detector is configured to compare the filtered power voltage and the charged filtered power voltage to detect the glitch.

7. The glitch detector of claim 3, wherein the glitch detection circuitry comprises an up glitch detector configured to detect the glitch as a surge in the digital power voltage on the digital power rail, the asymmetric memory element being responsive to the up glitch detector so as to generate the glitch detection signal in the detection state in response to the up glitch detector detecting the glitch as the surge in the digital power voltage on the digital power rail.

8. The glitch detector of claim 7, wherein the glitch detection circuitry further comprises:
a first filter circuit configured to receive the digital power voltage on the digital power rail and filter noise out of the digital power voltage so as to generate a filtered power voltage; and
a second filter circuit configured to receive the filtered power voltage so as to generate a charged filtered power voltage, the second filter circuit being configured to store charge from the filtered power voltage to generate the charged filtered power voltage so that a response to the glitch is slower on the charged filtered power voltage than on the filtered power voltage.

9. The glitch detector of claim 8, wherein the up glitch detector is configured to compare the filtered power voltage and the charged filtered power voltage to detect the glitch.

10. The glitch detector of claim 1, wherein the asymmetric memory element comprises:
P-channel field effect transistors (PFETs); and
N-channel field effect transistors (NFETs), wherein the asymmetric memory element is asymmetric such that leaking the charge from the asymmetric memory element drives the asymmetric memory element to generate the glitch detection signal in the detection state by having the NFETs larger than the PFETs.

11. The glitch detector of claim 10, wherein the asymmetric memory element further comprises:
second PFETs; and
second NFETs, wherein the asymmetric memory element is asymmetric such that leaking the charge from the asymmetric memory element drives the asymmetric memory element to generate the glitch detection signal in the detection state by having the second PFETs larger than the second NFETs, wherein the PFETs are first PFETs and the NFETs are first NFETs.

12. The glitch detector of claim 1, wherein the asymmetric memory element comprises:
P-channel field effect transistors (PFETs); and
N-channel field effect transistors (NFETs), wherein the asymmetric memory element is asymmetric such that leaking the charge from the asymmetric memory element drives the asymmetric memory element to generate the glitch detection signal in the detection state by having the PFETs larger than the NFETs.

13. The glitch detector of claim 1, wherein the asymmetric memory element comprises:
a first logic gate, the first logic gate comprising:
first P-channel field effect transistors (PFETs); and
first N-channel field effect transistors (NFETs), wherein the asymmetric memory element is asymmetric such that leaking the charge from the asymmetric memory element drives the asymmetric memory element to generate the glitch detection signal in the detection state by having the first NFETs larger than the first PFETs; and
a second logic gate, the second logic gate comprising:
second PFETs; and
second NFETs, wherein the asymmetric memory element is asymmetric such that leaking the charge from the asymmetric memory element drives the asymmetric memory element to generate the glitch detection signal in the detection state by having the second PFETs larger than the second NFETs.

14. The glitch detector of claim 13, wherein the asymmetric memory element comprises a set-reset (SR) latch and the first logic gate is a first NOR gate and the second logic gate is a second NOR gate.

15. A method of manufacturing a glitch detector, the method comprising:
forming glitch detection circuitry configured to be coupled to a digital power rail, the glitch detection circuitry being configured to detect a glitch on a digital power voltage on the digital power rail; and
forming an asymmetric memory element operably associated with the glitch detection circuitry so as to generate a glitch detection signal that is either in a detection state or a non-detection state, the asymmetric memory element being configured to generate the glitch detection signal in the detection state in response to the glitch detection circuitry detecting the glitch on the digital power voltage on the digital power rail, the asymmetric memory element being configured asymmetrically such that leaking charge from the asymmetric memory element drives the asymmetric memory element to generate the glitch detection signal in the detection state.

16. A digital circuit, the digital circuit comprising:
digital logic;
a digital power rail coupled to the digital logic, the digital power rail configured to receive a digital power voltage; and
a glitch detector, comprising:
glitch detection circuitry configured to be coupled to the digital power rail, the glitch detection circuitry being configured to detect a glitch on the digital power voltage on the digital power rail; and
an asymmetric memory element operably associated with the glitch detection circuitry so as to generate a glitch detection signal that is either in a detection state or a non-detection state, the asymmetric memory element being configured to generate the glitch detection signal in the detection state in response to the glitch detection circuitry detecting the glitch on the digital power voltage on the digital power rail, the asymmetric memory element being configured asymmetrically such that leaking charge from the asymmetric memory element drives the asymmetric memory element to generate the glitch detection signal in the detection state.

17. The digital circuit of claim 16, wherein the asymmetric memory element is configured to generate the glitch detection signal in the non-detection state in response to the glitch detection circuitry not detecting the glitch on the digital power voltage on the digital power rail.

18. The digital circuit of claim 17, wherein:
the asymmetric memory element is configured to receive a reset signal, the reset signal being in either a reset state or a non-reset state, wherein the asymmetric memory element being configured asymmetrically such that, at start up, the asymmetric memory element starts up in the detection state, wherein the asymmetric memory element is configured to be set in the non-detection state in response to the reset signal being in the reset state.

19. The digital circuit of claim 18, wherein the glitch detection circuitry comprises a down glitch detector configured to detect the glitch as a drop in the digital power voltage on the digital power rail, the asymmetric memory element being responsive to the down glitch detector so as to generate the glitch detection signal in the detection state in response to the down glitch detector detecting the glitch as the drop in the digital power voltage on the digital power rail.

20. The digital circuit of claim 19, wherein the glitch detection circuitry further comprises:
a first filter circuit configured to receive the digital power voltage on the digital power rail and filter noise out of the digital power voltage so as to generate a filtered power voltage; and
a second filter circuit configured to receive the filtered power voltage so as to generate a charged filtered power voltage, the second filter circuit configured to store charge from the filtered power voltage to generate the charged filtered power voltage so that a response to the glitch is slower on the charged filtered power voltage than on the filtered power voltage.
